(19) United States
(12) Patent Application Publication
(10) Pub. No.: US 2014/0143728 A1
(43) Pub. Date: May 22, 2014

(54) ERGONOMIC THUMB INTERFACE FOR MOBILE PHONE, SMART PHONE, OR TABLET

(71) Applicant: Loopwirez, Inc., Wilmington, DE (US)

(72) Inventors: Lonnie D. Coleman, JR., Hercules, CA (US); Charles T. Marshall, Atherton, CA (US)

(73) Assignee: Loopwirez, Inc., Wilmington, DE (US)

(21) Appl. No.: 14/081,734

(22) Filed: Nov. 15, 2013

Related U.S. Application Data
(60) Provisional application No. 61/727,633, filed on Nov. 16, 2012.

(51) Int. Cl. G06F 3/0482

(52) U.S. Cl. CPC G06F 3/0482
USPC 715/835

(57) ABSTRACT

An ergonomic graphical user interface in a mobile device allows a user to use the mobile device effectively with one hand. The ergonomic user interface organizes icons representing related application programs into common arcs. Such arcs serve as a convenient gateway to apps of a specific context category and thus enhance the ability to comfortably use the mobile device using only one hand. The advantages are achieved by basing the interface design on ease of interaction with the touch screen using the natural range of motion of the human thumb. Related application programs may share data, information and resources. A sever may interact with the related applications to provide additional services and analytical information based on the shared data.

### CROSS REFERENCE TO RELATED APPLICATIONS

The present application relates to and claims priority of U.S. provisional patent application (“Copending Provisional Application”), Ser. No. 61/727,633, entitled “ERGONOMIC THUMB INTERFACE FOR MOBILE PHONE, SMART PHONE, OR TABLET,” filed on Nov. 16, 2012. The disclosure of the Copending Provisional Application is hereby incorporated by reference in its entirety.

### BACKGROUND OF THE INVENTION

1. Field of Invention

The present invention relates to an interface design that allows the user of a mobile device (e.g., a smart telephone, or a tablet computer) to interact with the device using only one hand, taking advantage of the natural range of motion of the human thumb.

2. Discussion of the Related Art

Current mobile devices have user interfaces that require the user to interact using rectilinear motion (e.g., up, down, left or right) that is based on 90-degree angles. In such a design, the user primarily interacts with the device by holding the device in one hand, and using the index finger, forefinger or fingers in the off-hand. Such interactions are not satisfactory because, to execute certain actions, the user is required to use the off-hand or to execute unnatural motions of the thumb, which can be quite uncomfortable for the user. The current designs also do not offer a user interface that is designed to be used with only one hand.

### SUMMARY OF INVENTION

The present invention provides an ergonomic thumb interface, which allows the user to comfortably execute desired interactions with mobile devices (e.g., smart telephones, and tablet computers) by swiping and tapping in an ergonomically favorable manner that minimizes unnatural motions of the thumb. The ergonomic thumb interface is designed with a focus on the human thumb; and, specifically, on the natural radial range of motion of the human thumb.

According to one embodiment of the present invention, a user interface is designed for a user to interact with it using the natural range of motion of the thumb. In that embodiment, the user interface incorporates objects along a quarter-circular arc or curved area that is defined by the sweep of the natural movement of the thumb. Within this curved area, the user may make swipe and tap gestures with the thumb to activate the executable programs represented by the graphical objects. In this manner, the user is no longer required to use the off-hand or to use unnatural repetitive movements involving the thumb or other digits.

The simpler, safer and more refined way for a user to access his or her mobile devices, according to the present invention, has many advantages. For example, users who access a large amount of information, or who access information frequently throughout the day, need no longer be concerned about the repetitive motions and the physical strain associated with these movements. The simplified approach of the present invention releases the user from having to repeatedly adjust hand positions, such as to swipe left to right, or up and down, and tap. By focusing on the natural range of motion of the thumb, the present invention addresses and corrects ergonomic inefficiencies, while maximizing physical comfort. In one embodiment, the user may operate a mobile device effectively and efficiently using only one hand. As a result, the present invention reduces both strain and the wear and tear on hand ligaments that results from repeated use.

The curved area provides a special “real estate” in the user interface of a mobile device in which the user of a provider of application programs (“apps”) to organize related apps, so as to allow the user easy access to apps that are related or are often used together. In addition, related apps may be integrated using application program interfaces to allow interactions, to share resources and to share and track usage data or other information valuable to app providers.

The present invention reduces the strain and the wear and tear of hand ligaments that result from repeated use by reducing the amount of flexion in one or more of the distal interphalangeal joint, proximal interphalangeal joint, metacarpalphalangeal joint, and carpometacarpol (basilar) joint.

The present invention is better understood upon consideration of the detailed description below in conjunction with the accompanying drawings.

### BRIEF DESCRIPTION OF THE DRAWINGS

FIG. 1 shows a graphical user interface in landscape mode, having filters set out in concentric circular arcs for access by the user's thumbs, in accordance with one embodiment of the present invention.

FIGS. 2-8 each show, in a selected graphical user interface, a set of filters and a display of content, according to one embodiment of the present invention.

FIG. 9 illustrates one graphical user interface design, in accordance with one embodiment of the present invention.

FIGS. 10(a) and 10 (b) show two screen shots of graphical user interfaces in accordance with one embodiment of the present invention.

FIG. 11 illustrates a method for providing and managing a bundle of apps, in accordance with one embodiment of the present invention.

FIGS. 12(a) and 12(b) show swipe tab 110 provided to expose and hide the arc interface, respectively, in accordance with one embodiment of the present invention.

FIG. 13 shows, based on the user's interaction with web page 501, message 503 being sent to mobile device 502, in accordance with one embodiment of the present invention.

FIG. 14 illustrates a process by which Arc Interface-compatible related app 505 detects that the context of web page 501 causing server 403 to send context-relevant message 503 to mobile device 502, in accordance with one embodiment of the present invention.

FIG. 15 illustrates server 403 including in context-relevant message 503 a download widget 506 for downloading a data object or an app, in accordance with one embodiment of the present invention.

FIG. 16 shows downloading simultaneously a bundle of apps, when a user of mobile device 502 indicates downloading any app within the bundle of app, in accordance with one embodiment of the present invention.

FIG. 17 shows that using thumb pressure in conjunction with a rolling thumb motion may be used to indicate commands to expand or constrict a displayed angle of an arc, in accordance with the present invention.

FIG. 18 illustrates, in a graphical display of the mobile device with a curved screen, the directions of a thumb rolling motion that may be used to express two commands, in accordance with one embodiment of the present invention.

### DETAILED DESCRIPTION OF THE PREFERRED EMBODIMENTS

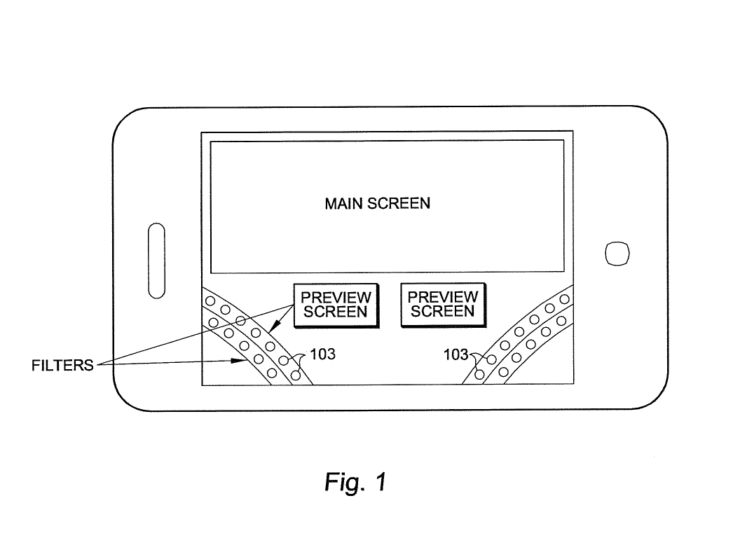

In one embodiment of the present invention, a user uses just the thumb to select objects (“filters”) displayed on a graphical user interface of a mobile device (e.g., a smart telephone, or a tablet computer) to invoke desired actions, such as executing a desired program on the mobile device. FIG. 1 shows, for example. FIG. 1 shows a graphical user interface in landscape mode, having filters 103 set out in concentric quarter-circular arcs for access by the user's thumbs, in accordance with one embodiment of the present invention. The quarter-circular arc design utilizes a comfortable angle that is the natural range of motion for the thumb, which is vital to one hand manipulation. In this detailed description, the user interface of the present invention is termed “Arc Interface” for clarity.

The Arc Interface takes into account the three comfort zones of the hand to allow one-hand manipulation. The three comfort zones (i.e., the palmar digital, the distal palmar, and the proximal palmar) provide decreasing comfort as the interphalangeal and metacarpo-phalangeal joint flexest slides across the palmar digital, distal palmar, and proximal palmar of the hand. This design reduces the strain and discomfort, even under constant use of the muscles, tendons, joints, and ligaments.

The palmar digital allows the sweeping movement between the radial border and the ulnar border. This zone provides the most comfort for the hand as the distal phalanx sweeps across the palmar digital zone reducing the flex of the interphalangeal and metacarpophalangeal flex. In this zone, a design under the present invention utilizes a half moon semi circle design, which allows the user to scroll across this zone with the least amount of flexion of the interphalangeal and metacarpophalangeal bone and ligaments.

The digital palmar, which is second in the hierarchy of comfort, is the interaction of the distal phalanx as it sweeps across the distal palmar from the radial border to the ulnar border. Due to the flexion of the interphalangeal and metacarpophlangeal joint, this movement is less comfortable and places strain on the nerves, muscles and tendons of the hand and thumb.

The proximal palmar, which is third in the hierarchy of comfort, is the interaction of the distal phalanx, as it sweeps across the proximal palmar from the radial border to the ulnar border. This movement is the least comfortable of the three zones, because as the distal phalanx moves across the hand towards the proximal palmar, this movement also comes closer to the hypothenar. The proximal palmar forces the most hand flexion and thus reduces comfort as more tension, friction, and pressure is placed on the carpometacarpol bones and joints as it interacts with the thenar.

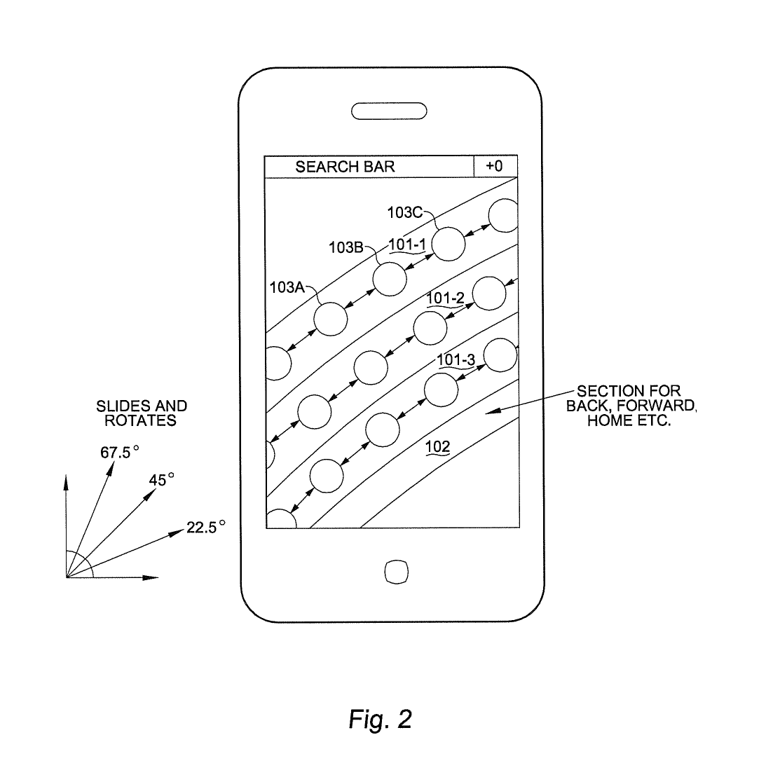

The present invention takes advantage of these anatomical facts to incorporate into the Arc Interface various graphical user interface designs. For example, FIGS. 2-8 each show a layout of filters and content in one selected graphical user interface, according to one embodiment of the present invention. FIGS. 2-8 show filters placed along concentric arcs. FIG. 2 shows, in addition to placing filters along concentric arcs 101-1, 101-2, and 101-3, section 102 for a user to indicate user interface commands for a selected arc, such as back, forward, and home. FIGS. 10(a) and 10(b) show two screen shots of graphical user interfaces in the style of the present invention. FIG. 10(a) shows preview screen 10-1 of a web page, while FIG. 10(b) shows that web page in full screen.

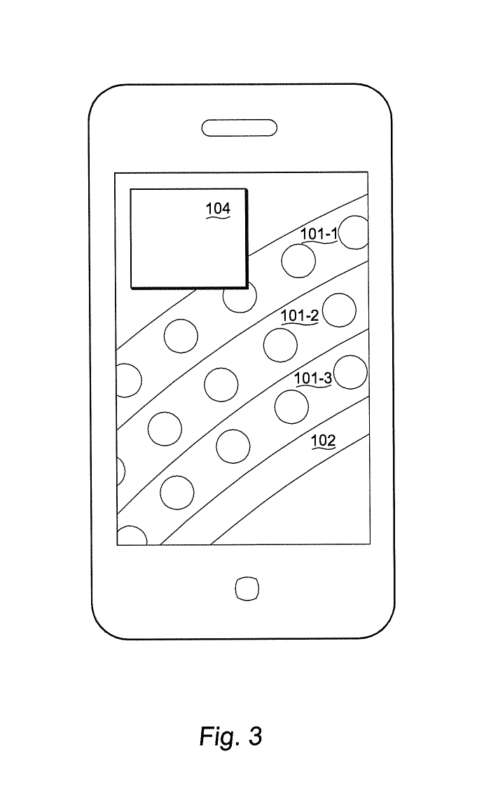

FIG. 3 provides rectangular view port 104 at the upper corner of the user interface to provide a preview for a selected one of the filters (e.g., showing a current thumbnail view of a frequently visited web page).

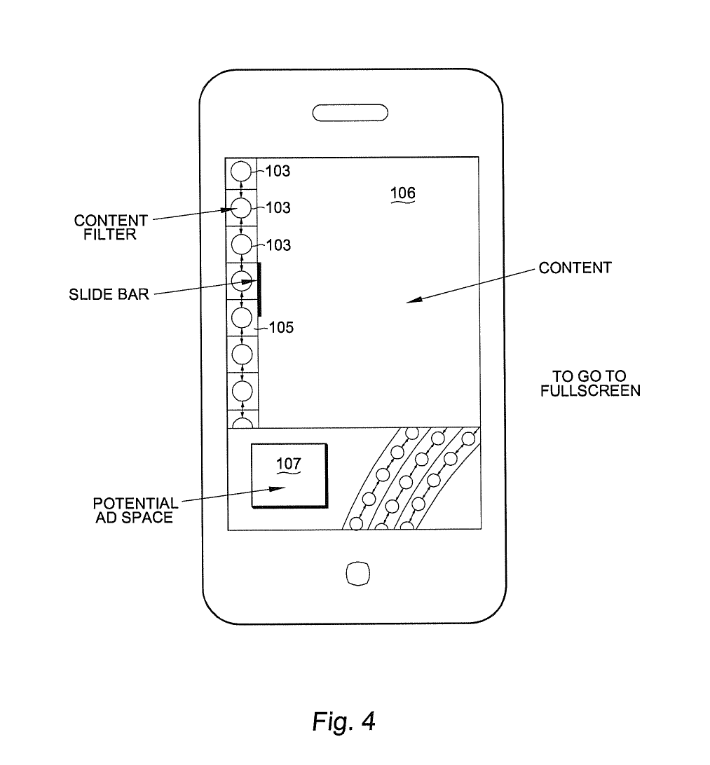

FIG. 4 shows content filter bar 105 along the left hand edge of the Arc Interface to display a number of content filters (indicated by reference numerals 103) which may be applied to the content being viewed (e.g., viewport 106). One example of using content filter bar 105 is in a search operation. In that application, each content filter may represent an option or a further-limiting search term that would narrow the search result further. Alternatively, content filter bar 105 may be implemented as a slide bar that may be hidden or displayed according to the preference of the user, as indicated by a gesture, so as to allow viewing the displayed content in a maximum or reduced area, as desired. FIG. 4 also shows area 107 where other information (e.g., an advertisement) may be placed.

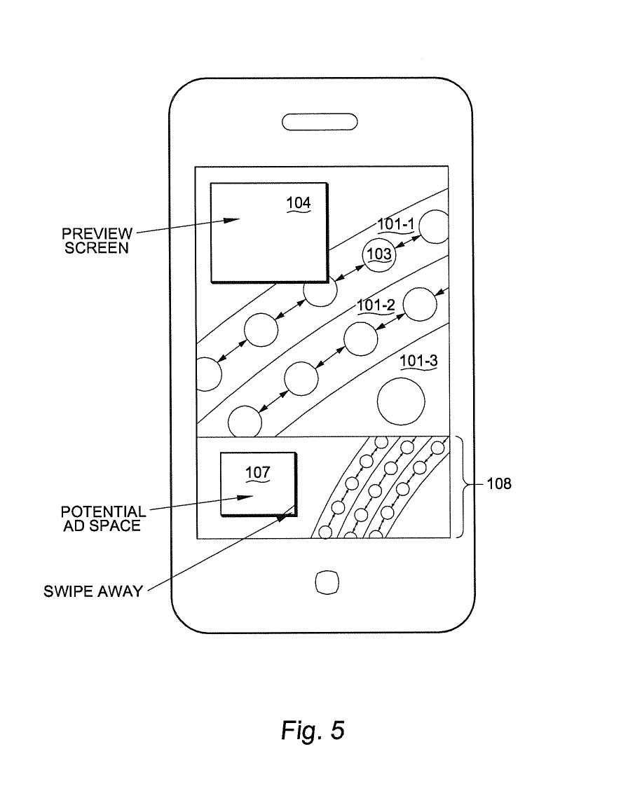

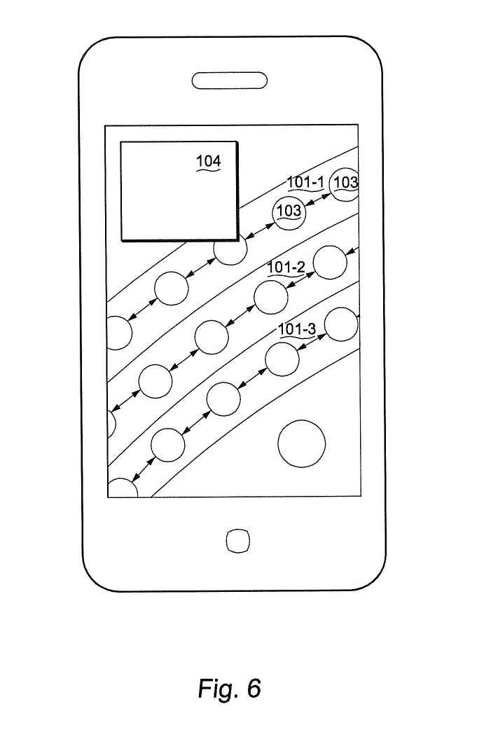

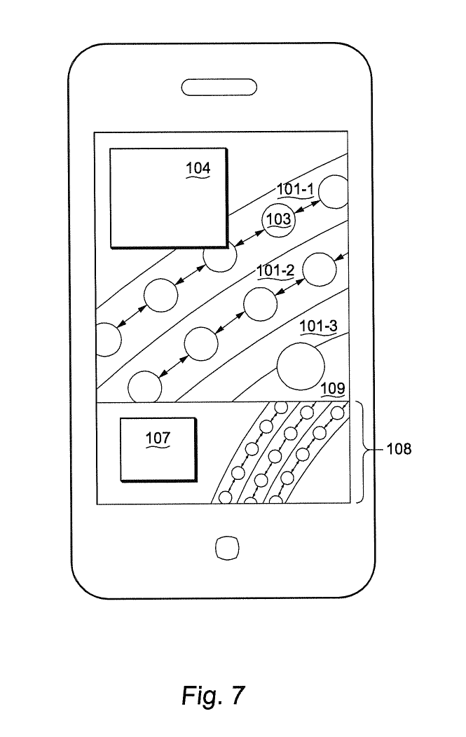

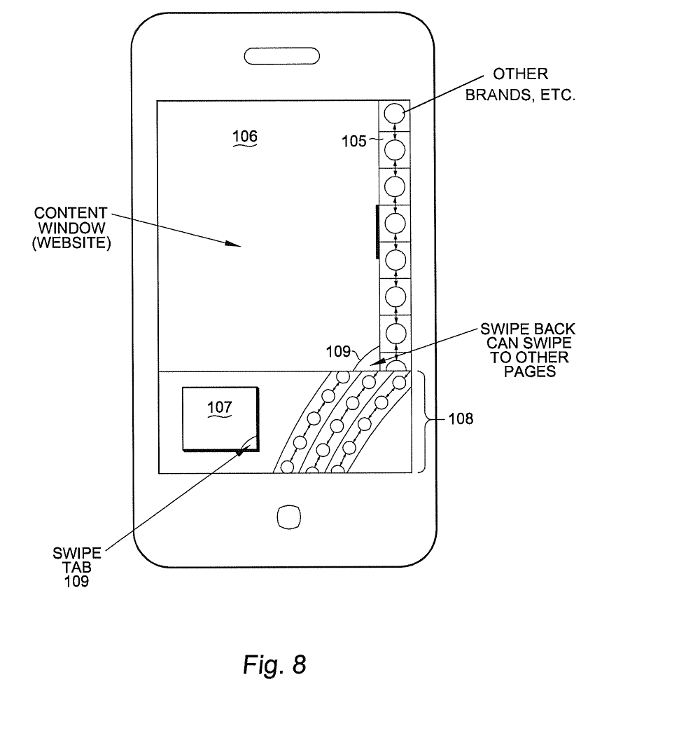

FIG. 5 shows the Arc Interface providing preview area 104 and advertising space 107 in additional information region 108, which can be removed (i.e., hidden) from the user interface by a swiping gesture of the user's thumb. FIG. 6 shows the graphical interface with additional information region 108 hidden. FIG. 7 shows that additional information region 108 reappears when the user clicks on a “brand” button, showing, in addition to advertising space 107, a selectable new page of user interface in additional information region 108. FIG. 8 also provides in viewport 106 swipe tab 109 to allow a user to sequentially view content (e.g., moving from one web page to another web page) using a tab or swipe gesture on swipe tab 109.

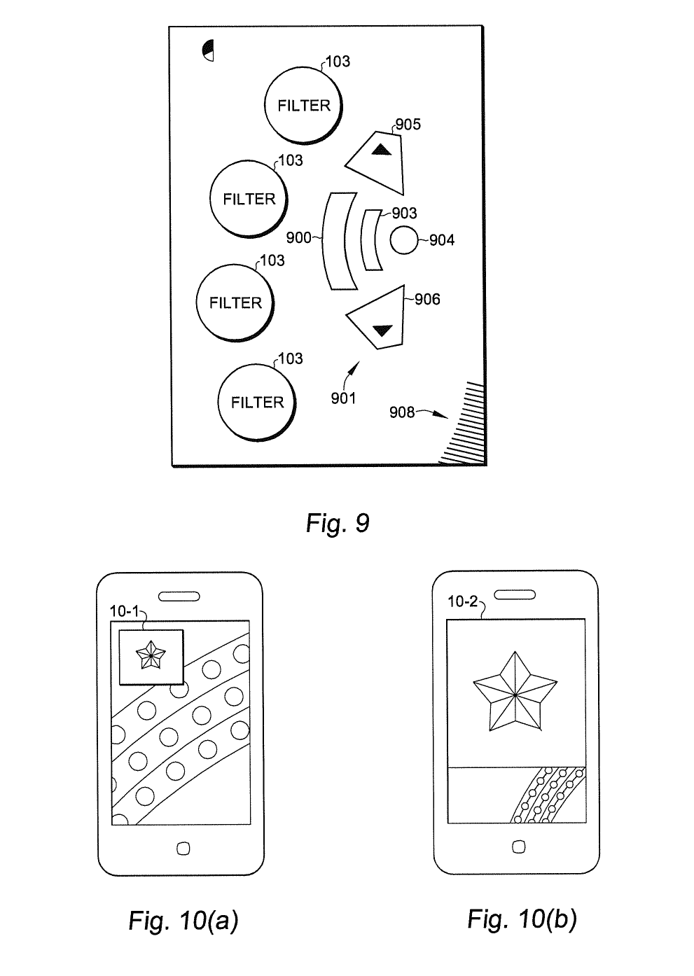

FIG. 9 illustrates one graphical user interface design for the Arc Interface, in accordance with one embodiment of the present invention. In FIG. 9, a set of filters is strategically placed to allow easy access using a thumb. In addition, navigation device 901 is provided. For example, amphitheater style buttons 902, 903 and 904 shown, allows a user to page through (i.e., backwards, forwards and select) different sets of filters. A loop cycle including direction buttons 905 and 906 allows sequentially cycling through options of a selected displayed filter, and xylophone style cancel button 908 may be used to communicate cancellation of an action.

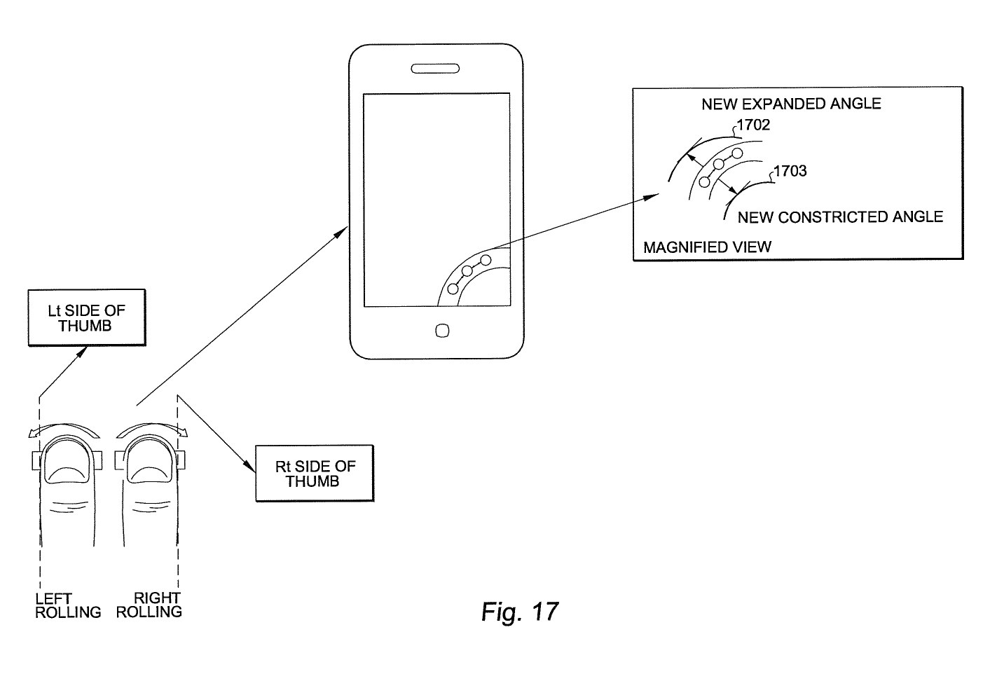

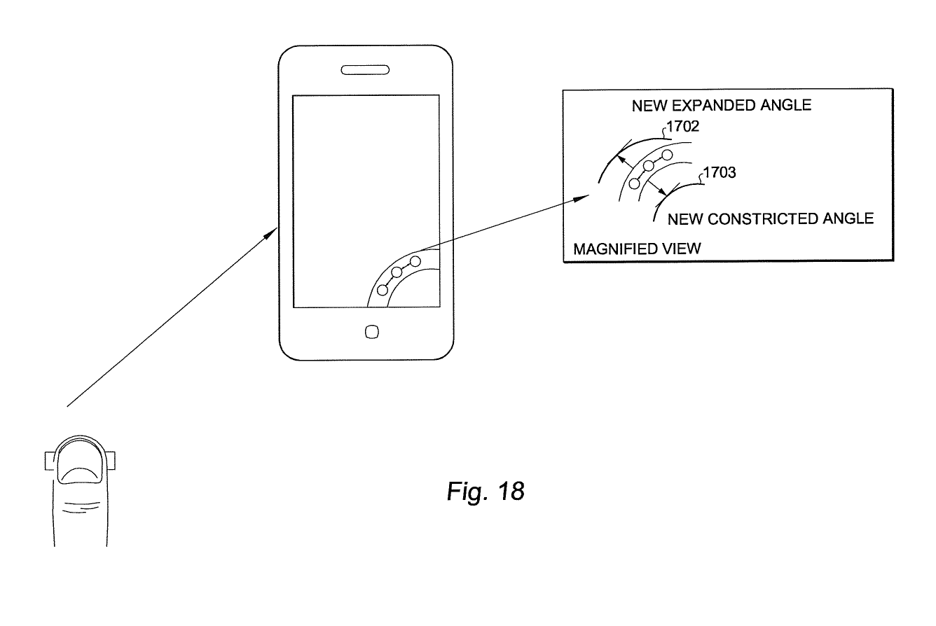

Besides using thumb motions to represent commands, pressure asserted by the thumb may also be used. FIG. 17 shows that using thumb pressure in conjunction with a rolling thumb motion may be used to indicate commands to expand or constrict a displayed angle of an arc. For example, as shown in FIG. 17, when the user asserts thumb pressure on an arc, while at the same time rolls the thumb in a right to left motion. the Arc Interface recognizes the pressure and rolling motion combination to be a command to expand the arc to the position indicated by arc 1702. Conversely, when the user asserts thumb pressure on an arc, while at the same time rolls the thumb in a left to right motion, the Arc Interface recognizes the pressure and rolling motion combination to be a command to constrict the arc to the position indicated by arc 1703. If the graphical display of the mobile device has a curved screen, rolling motion directions themselves may be used to express the two commands, as illustrated in FIG. 18.

One advantage of the Arc Interface is that numerous apps may be operating without having to close out each app individually, such as required under the IOS operating system in the iPad, iPhone or iPod devices from Apple Computer, Inc. Under IOS operating system, the user is required to close out an application using the “home” button. In a user interface of the present invention, any app provided as a filter may be activated simply by tapping on the filter using the thumb.

Each arc or curved area can accommodate a number of apps and represent a valuable “real estate” for providers of goods and services to interact with potential customers. For example, a sponsor may promote its brands, along with its business partners, by offering related apps of a specific category (“a bundle of apps”) to the user for placement in the same arc. One of the related apps may be designated a core app of the special category to which other apps in the bundle provide support. Such an arc then becomes a gateway that facilitates easy access by the user to the specific category. For example, a health insurance may offer a user (e.g., under a category “your health”) a bundle of apps, including: (a) its own directory app for its in-network preferred health care providers; (b) its own app for managing the user's out-of-pocket health care costs; (c) a network pharmacy's app for managing the user's prescription medication: (d) a third party app for accessing fitness information; and (e) a third party app for nutrition information to manage the user's dietary needs. According to one embodiment of the present invention, these related apps may be developed using a common software development kit that provides an application program interface (API) to allow these apps to share resources, data and other information and to invoke each other's functionalities. The API may also allow the apps to collect and send usage information and data (e.g., frequency and times each app is accessed or the user's response to specific advertising campaign) to a common data server, so as relevant analytic information may be compiled for the providers. Such analytical information is often essential for the providers to improve their products and services to respond to changing consumer habits and preferences, and market conditions. Using this common information, the providers may send timely messages to the user, such as tips for a healthy diet, reminders of medical appointments, coupons for health foods, exercise equipment, or eyewear. This integrated and cooperative approach for marketing related goods and services has been proven to be effective for providers to establish and promote their brands and to evaluate co-branding, or other business partner relationships.

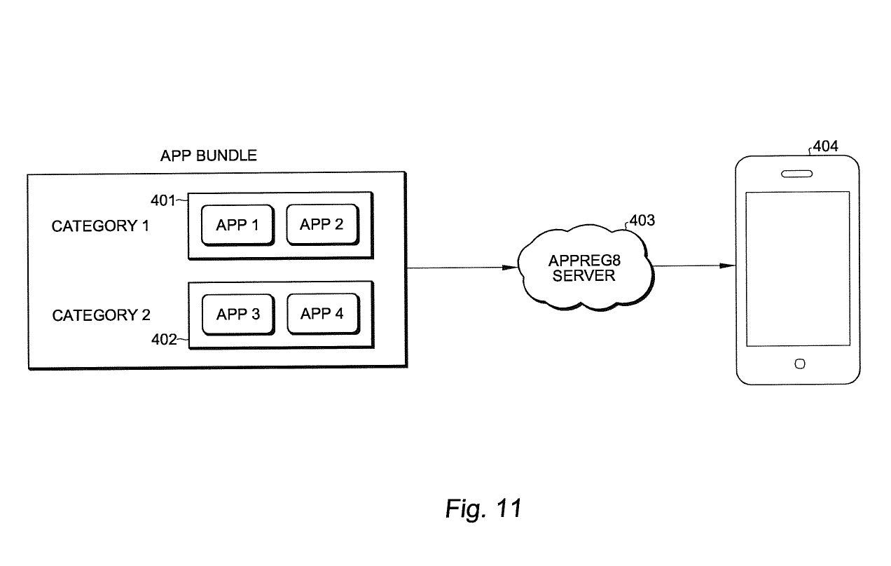

According to one embodiment of the present invention, a bundle of apps may be provided and managed along with the Arc Interface by a service provider according to a method illustrated in FIG. 11. The service provider may provide potential advertisers a software development kit (SDK) that includes an API which allows interactions between apps and common resource and data sharing, as discussed above. Using the tools provided in the SDK, the customers and their business partners may develop bundles of apps for different categories (e.g., bundles 401 and 402 in FIG. 11). In this detailed description, an app developed using such an SDK is referred to as a “Arc Interface-compatible app.” These app bundles, which may be take the form of .apk files (to be run, for example, under the Android operating system), are loaded in server 403 on a wide area network that is accessible by the target mobile devices, such as mobile device 404 of FIG. 4. Using, for example, the mechanisms discussed below, server 403 provides mobile device 404 selected app bundles. The delivery mechanism may be, for example, based on web page interactions, such as those using the javascript object notation (JSON) convention.

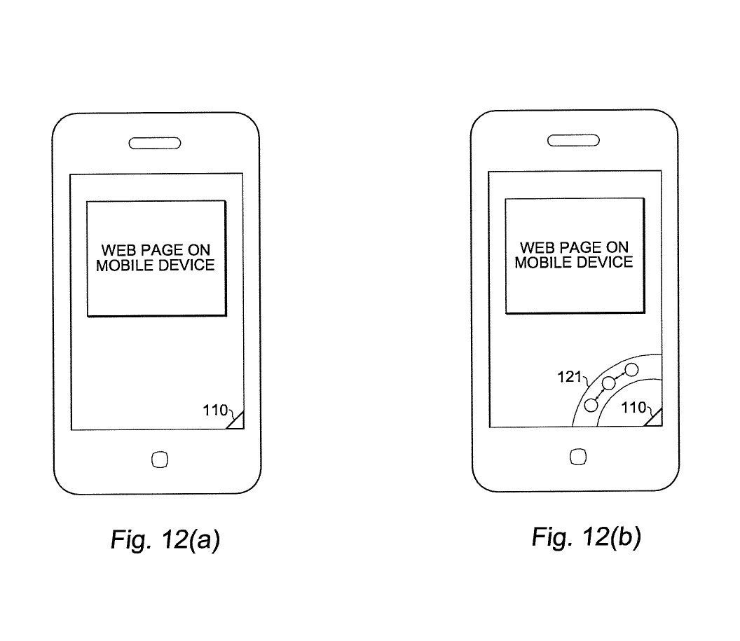

To be able to receive app bundles from server 403, mobile device 404 runs an app that provides the Arc Interface of FIGS. 2-9 described above. In one implementation of the Arc Interface, for example, as illustrated in FIGS. 12(a) and 12(b), swipe tab 110 is provided to expose and hide arc 121, in accordance with one embodiment of the present invention. With arc 121 hidden, the user interface operates substantially the same manner as the user interface of the native operating system.

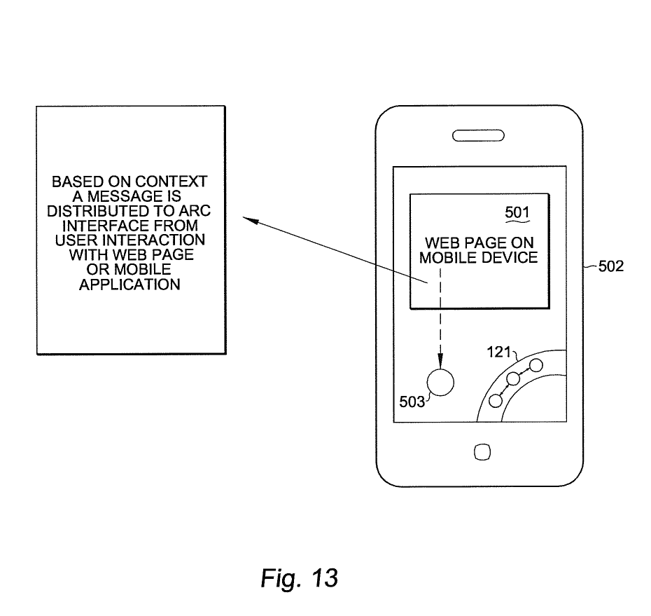

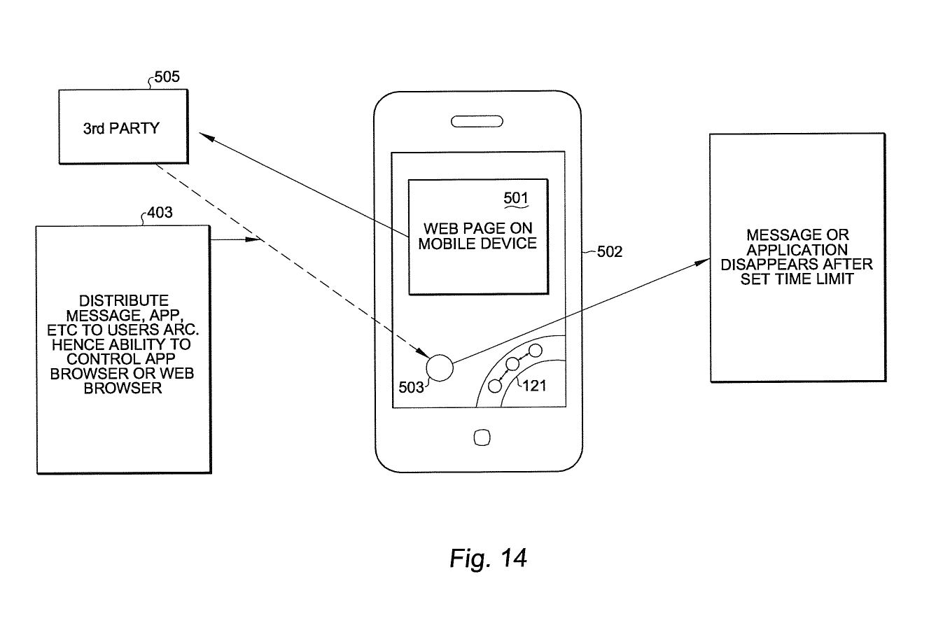

An app developed using the API of the present invention is able to interact with the user using resources of the Arc Interface. FIG. 13 shows, based on the user's interaction with web page 501, message 503 being sent to mobile device 502, in accordance with one embodiment of the present invention. As shown in FIG. 13, a user interacts with web page 501, which may be accessed through any general web browser or through any app that is developed with the SDK mentioned above. If the web page is accessed through an Arc Interface-compatible app, or if the web page itself is Arc Interface-compatible, the Arc Interface-compatible app or web page may cause server 403 (FIG. 4) to send context-relevant message 503 to mobile device 502. In FIG. 13, context-relevant message 503 is sent as a filter in the Are Interface. It may, for example, be placed in a relevant arc. Alternatively, as illustrated in FIG. 14, Arc Interface-compatible related app 505 running on mobile device 503 (e.g., a related app in a bundle) detects that the context of web page 501 to be relevant to it, Arc Interface-compatible app may cause server 403 to send context-relevant message 503 to mobile device 502. Using the health care app bundle example above, for example, if web page 501 relates to aerobic exercises, context-relevant message 503 may be a link to further information regarding aerobic exercises from the provider of the fitness information app. Message 503 may appear on the Arc Interface only for a predetermined amount of time before being removed from the Arc Interface.

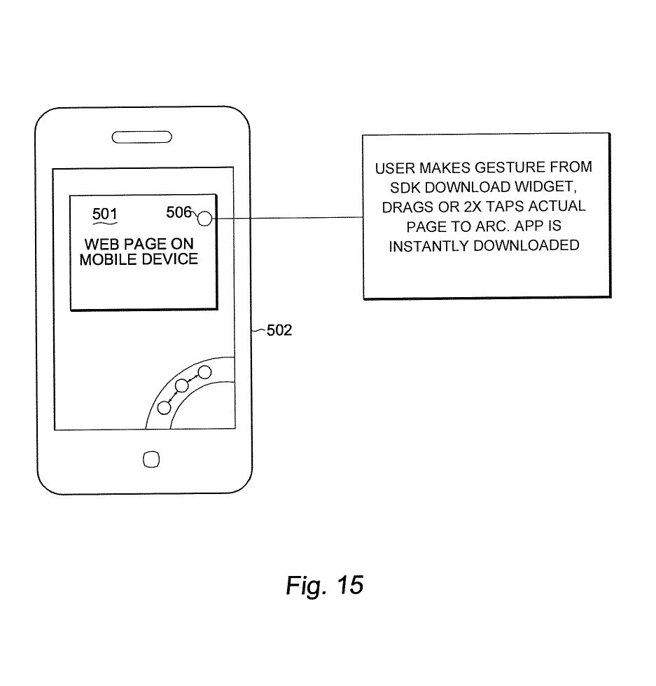

In one embodiment, as illustrated in FIG. 15, server 403 may include download widget 506 in context-relevant message 503 for downloading a data object or an app. The user may double tap or gesture (e.g., dragging the download widget to a relevant arc) to activate the download procedure.

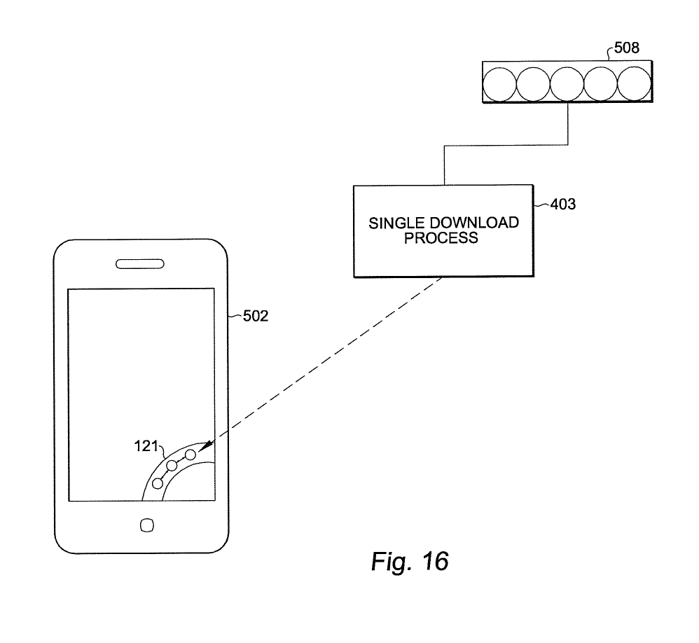

An app selected by a user of mobile device 502 may be part of a bundle of apps. In that instance, the entire bundle may be downloaded simultaneously, as illustrated by FIG. 16. As shown in FIG. 16, when the user initiates the download, server 403 selects bundle 508 in which the selected app is a member. The bundle is installed in mobile device 502 with an association to an arc suitable for accommodating the bundle of apps 508.

The above detailed description is provided to illustrate the specific embodiments of the present invention and is not intended to be limiting. Numerous variations and modifications within the scope of the invention are possible. The present invention is set forth in the accompanying claims.

What is claimed is:

1. A method for a graphical user interface for a mobile device, comprising:
displaying a set of graphical objects on the user interface arranged to be selectable by a user using a thumb while holding the mobile device in the hand of the thumb, the graphical objects each being associated with a program that can be executed on the mobile device;
receiving the user's selection of one of the graphical objects by detecting a gesture performed by the thumb; and
executing the program associated with the selected graphical object.

2. The method of claim 1, wherein the graphical objects are laid out in the graphical user interface taking into account the natural range of motion angle that maximizes comfort to the user.

3. The method of claim 1, wherein the graphical objects are laid out along one or more circular arcs.

4. The method of claim 1, wherein the graphical objects are laid out along one or more crescents.

5. The method of claim 1, wherein the graphical objects are laid out in a manner that reduces the pressure or strain on the distal interphalangeal joint, the proximal interphalangeal joint, the metacarpolphalangeal joint or the carpometacarpol (basilar) joint.

6. The method of claim 1, wherein the graphical objects are laid out in a manner that increases ergonomic thumb efficiency.

7. The method of claim 6, wherein the ergonomic thumb efficient is achieved by improving the movement of the thumb as it moves from the radial border of the hand to the ulnar border of the hand.

8. The method of claim 6, wherein the ergonomic thumb efficiency is achieved by improving the range of motion and comfort as the hand moves from the radial border of the hand to the ulnar border of the hand.

9. The method of claim 6, wherein the ergonomic thumb efficiency is achieved by improving the relationship of the distal phalanx as it interacts with the palmar digital, distal palmar, and proximal palmar.

10. The method of claim 6, wherein the ergonomic thumb efficiency is achieved by reducing flexion strain as the thumb rotates and abducts through the radial side of the hand to the ulnar side of the hand.

11. The method of claim 6, wherein the ergonomic thumb efficiency is achieved by increasing palmar abduction efficiency.

12. The method of claim 11, wherein the palmar abduction efficiency is achieved by increasing ergonomic efficiency of the thumb retro position

13. The method of claim 11, wherein the palmar abduction efficiency is achieved by increasing ergonomic efficiency of the thumb ante position.

14. The method of claim 11, wherein the palmar abduction efficiency is achieved by decreasing muscle strain or fatigue.

15. The method of claim 1, wherein the gesture comprises a sweeping motion of the thumb.

16. The method of claim 1, wherein the gesture comprises exerting a pressure by the thumb against a surface of the mobile device.

17. The method of claim 1, wherein the gesture comprises a rolling motion of the thumb.

18. The method of claim 1, wherein two or more of the graphical objects represent related application programs that communicate over an application program interface.

19. The method of claim 18, wherein the related application programs are capable of executing functionalities of each other over the application program interface.

20. The method of claim 18, wherein the related application programs belong to a specific category and are grouped together by a server.

21. The method of claim 20, wherein the related application programs share information with the server and with each other.

22. The method of claim 21, wherein the information comprises usage statistics.

23. The method of claim 21, wherein the server analyzes the shared data to provide reports to sponsors of the related application programs.

24. The method of claim 30, wherein the related application are downloaded together as a group to the mobile device.

25. The method of claim 24, wherein the group of related application programs are represented by graphical objects sharing an arc in the graphical user interface.

26. The method of claim 20, wherein the server sends context-relevant messages to the mobile device based on the shared information.

27. The method of claim 18, wherein the related application programs are provided by two or more different sponsors sharing a business partnership.
